(19) United States
(12) Patent Application Publication
(10) Pub. No.: US 2026/0356739 A1
(43) Pub. Date: Nov. 12, 2026

(54) GLASS FIBER AND COMPOSITION FOR GLASS FIBER

(71) Applicant: Nippon Sheet Glass Company, Limited, Tokyo (JP)

(72) Inventor: Aya NAKAMURA, Liverpool (GB)

(21) Appl. No.: 19/130,758

(22) PCT Filed: Nov. 8, 2023
(86) PCT No.: PCT/JP2023/040292

§ 371 Date: May 16, 2025

(30) Foreign Application Priority Data
Nov. 16, 2022 (JP) 2022-183742

(51) Int. Cl. C03C 13/00; C03C 3/095

(52) U.S. Cl. CPC C03C 13/007; C03C 3/095

(57) ABSTRACT

The present disclosure provides a glass composition for a glass fiber, the glass composition including, in mass %: SiO₂ 50 to 65%; Al₂O₃ 10 to 30%; MgO 10 to 20%; CaO 0 to 7%; TiO₂ 0 to 5%; and ZrO₂ 0 to 5%, where a sum of a SiO₂ content, a TiO₂ content and a ZrO₂ content is 58% or more, a sum of the TiO₂ content and the ZrO₂ content is 0.1% or more, and when a MgO content is 10% or more and less than 16%, the glass composition contains 0.1% or more of ZrO₂.

### TECHNICAL FIELD

The present invention relates to a glass fiber and a glass composition suitable for a glass fiber.

### BACKGROUND ART

Although many of glass fibers in practical use are formed of a glass composition having a Young's modulus of 90 GPa or less, glass compositions having a Young's modulus of more than 90 GPa are also known. For example, Patent Literature 1 discloses a glass composition including a large amount of rare-earth oxides. The total content of Y₂O₃ and La₂O₃ in the glass composition of Patent Literature 1 is in the range of 20 to 60 weight %. However, a high rare-earth oxide content increases the manufacturing cost. Taking this into account, Patent Literature 2 discloses a technique by which the Young's modulus of a glass composition is improved without a large amount of rare-earth oxides. The glass composition of Patent Literature 2 includes 15 to 30% MgO in mol % as a component for improving the Young's modulus.

### CITATION LIST

### Patent Literature

Patent Literature 1: WO 2006/057405 A1
Patent Literature 2: JP 6391875 B1

### SUMMARY OF INVENTION

### Technical Problem

Patent Literature 2 fails to specifically discuss an acid resistance of a glass composition. It is therefore an object of the present invention to provide a glass fiber having a high Young's modulus and a high acid resistance and a glass composition suitable for manufacturing such a glass fiber.

### Solution to Problem

Through studies on a blending ratio of glass components, the present inventor has completed a glass composition suitable for a glass fiber having an excellent balance between the acid resistance and the Young's modulus.

The present invention provides a glass composition for a glass fiber, the glass composition including, in mass %:
SiO₂ 50 to 65%;
Al₂O₃ 10 to 30%;
MgO 10 to 20%;
CaO 0 to 7%;
TiO₂ 0 to 5%; and
ZrO₂ 0 to 5%; where
a sum of a SiO₂ content, a TiO₂ content and a ZrO₂ content is 58% or more,
a sum of the TiO₂ content and the ZrO₂ content is 0.1% or more, and
when a MgO content is 10% or more and less than 16%, the glass composition includes 0.1% or more of ZrO₂.

The present invention provides also a glass fiber including the glass composition for glass fibers according to the present invention.

### Advantageous Effects of Invention

The present invention provides a glass fiber having an excellent balance between the acid resistance and the Young's modulus, and a glass composition for a glass fiber, the glass composition being suitable for such a glass fiber.

### DESCRIPTION OF EMBODIMENTS

Embodiments of the present invention will be described hereinafter. The following description is not intended to limit the present invention to particular embodiments. Herein, the content of each component in a glass composition below is in mass %, and mass % is basically represented by “%”. Herein, being “substantially free of” a component means that the content of the component is less than 0.1 mass %, less than 0.05 mass %, less than 0.01 mass %, less than 0.005 mass %, even less than 0.003 mass %, or, in some cases, less than 0.001 mass %. The adverb “substantially” is intended to mean that a small amount of impurities such as those derived from a glass raw material, a manufacturing apparatus, and the like may be contained. The term “alkali metal oxides” means Li₂O, Na₂O, and K₂O, and is sometimes referred to as R₂O. The upper and lower limits of each of the following contents can be suitably combined in both cases where the upper and lower limits are individually specified and where the upper and lower limits are expressed as a range.

### [Glass Composition]

### <Components>

Components that can form the glass composition of the present embodiment will be each described hereinafter.

### (SiO₂)

SiO₂ is a component that forms a glass network, and is also a component that adjusts the devitrification temperature and the viscosity during glass forming and that improves the acid resistance. A SiO₂ content is, for example, 50 to 65%. The lower limit of the SiO₂ content may be 55% or more, 57% or more, 57.5% or more, 58% or more, 59% or more, 59.6% or more, 59.8% or more, or even 60% or more. The upper limit of the SiO₂ content may be 63% or less, 62.3% or less, 62% or less, 61.8%, 61.5% or less, or even 61% or less. The SiO₂ content may be 55 to 62%, or even 57.5 to 61.5%.

(Al₂O₃)

Al₂O₃ is a component that adjusts the devitrification temperature and the viscosity during glass forming and that contributes to improvement of the water resistance of the resulting glass. An Al₂O₃ content is, for example, 10 to 30%. The lower limit of the Al₂O₃ content may be, for example, 15% or more, 17% or more, 19% or more, 19.5% or more, 19.7% or more, or even 20% or more. The upper limit of the Al₂O₃ content may be 28% or less, 25% or less, 22% or less, 21% or less, 20.8% or less, or even 20.6% or less. The Al₂O₃ content may be 15 to 30%, or even 19.7 to 20.6%. As described below, in the case where the MgO content is less than 16%, the Al₂O₃ content may be 22 to 29%, or even 23.5 to 28%.

(B₂O₃)

B₂O₃ is an optional component that forms a glass network and that adjusts the devitrification temperature and the viscosity during glass forming. A B₂O₃ content is, for example, 0 to 1.5%. The lower limit of the B₂O₃ content may be 0.02% or more. The upper limit of the B₂O₃ content may be 1.2% or less, 1% or less, 0.5% or less, 0.3% or less, 0.1% or less, or even 0.08% or less. The glass composition of the present embodiment may be substantially free of B₂O₃.

### (MgO)

MgO is a component that improves the Young's modulus and that affects the devitrification temperature, the viscosity, and the like. A MgO content is, for example, 10 to 20%. The lower limit of the MgO content may be 12% or more, 14% or more, 16% or more, 16.5% or more, 16.6% or more, 16.8% or more, or even 17% or more. The upper limit of the MgO content may be 19% or less, 18% or less, 17.8% or less, 17.7% or less, or even 17.6% or less. The MgO content may be 12 to 20%, or even 14 to 19%. In the case where the MgO content is less than 16%, addition of ZrO₂ is recommended.

### (CaO)

CaO is an optional component that adjusts the devitrification temperature and the viscosity during glass forming. A CaO content is, for example, 0 to 7%. The lower limit of the CaO content may be 0.1% or more, 0.3% or more, 0.5% or more, or even 0.7% or more. The upper limit of the CaO content may be 5% or less, 3% or less, 2% or less, 1.5% or less, 1.4% or less, 1.3% or less, 1.2% or less, or even 1% or less.

### (Alkali Metal Oxides)

Alkali metal oxides (R₂O) are optional components that adjust the devitrification temperature and the viscosity during glass forming. A total alkali metal oxide content, specifically, [Li₂O]+[Na₂O]+[K₂O], is, for example, 0 to 3%. The lower limit of the total alkali metal oxide content may be 0.05% or more, 0.1% or more, 0.2% or more, or even 0.3% or more. The upper limit of the R₂O content may be 2% or less, 1.5% or less, 1.2% or less, 1.0% or less, 0.9% or less, or even 0.8% or less. A high R₂O content can sometimes prevent a sufficient increase in Young's modulus.

A Li₂O content is, for example, 0 to 1.5%. The lower limit of the Li₂O content is 0.1% or more, or 0.2% or more, and may be 0.3% or more, or even 0.4% or more. The upper limit of the Li₂O content may be 1% or less, 0.8% or less, 0.6% or less, or even 0.5% or less. A preferred example of the Li₂O content is 0.1 to 0.8%. Li₂O has an advantage over Na₂O and K₂O in that both reduction of a Young's modulus decreasing effect and adjustment of properties such as the devitrification temperature are achieved. The Li₂O content may be higher than a Na₂O content, may be higher than a K₂O content, and may be higher than a sum of the Na₂O content and the K₂O content. However, the glass composition of the present embodiment may be substantially free of Li₂O.

A Na₂O content is, for example, 0 to 1%. The upper limit of the Na₂O content may be 0.5% or less, 0.2% or less, 0.18% or less, 0.15% or less, 0.13% or less, 0.1% or less, or even 0.08% or less. The glass composition of the present embodiment may be substantially free of Na₂O. A K₂O content is, for example, 0 to 0.5%. The upper limit of the K₂O content may be 0.3% or less, 0.1% or less, 0.08% or less, even 0.06% or less, or even 0.04% or less. The glass composition of the present embodiment may be substantially free of K₂O.

A sum of the Na₂O content and the K₂O content may be in the range of 0 to 1%, 0 to 0.5%, or even 0 to 0.3%.

(TiO₂ and ZrO₂)

TiO₂ and ZrO₂ are optional components that can contribute to improvement of the acid resistance. It is desirable to add at least one selected from TiO₂ and ZrO₂. In particular, it has been found that ZrO₂ is a component that can supplement the effect of MgO in improving the Young's modulus. The lower limit of a sum of the TiO₂ content and the ZrO₂ content may be 0.1% or more, 0.3% or more, 0.5% or more, 0.8% or more, 1% or more, or even 1.5% or more. The upper limit of a sum of the TiO₂ content and the ZrO₂ content may be 5% or less, 4% or less, 3.5% or less, 3% or less, or even 2.5% or less. In the present embodiment, for example, the sum of the TiO₂ content and the ZrO₂ content may be in the range of 0.5 to 5%, 0.8 to 4%, or even 1 to 3.5%.

TiO₂ and ZrO₂ are each added to account for, for example, 0 to 5%. A TiO₂ content and a ZrO₂ content may each be 0.1% or more, 0.3% or more, 0.5% or more, 1% or more, or even 1.2% or more. The TiO₂ content and the ZrO₂ content may each be 4% or less, 3% or less, 2.5% or less, or even 2% or less. The glass composition of the present embodiment may be substantially free of TiO₂ or ZrO₂.

### (ZnO)

ZnO is an optional component that may be added. ZnO is added to account for, for example, 0 to 3%, or even 0 to 1.5%. The upper limit of the ZnO content may be 1.4% or less, 1% or less, or even 0.5% or less. The glass composition of the present embodiment may be substantially free of ZnO.

### (F₂)

F₂ is also an optional component that may be added for refining or the like. F₂ is added to account for, for example, 0 to 0.5% or even 0 to 0.1%. The upper limit of the F₂ content may be 0.08% or less. The glass composition of the present embodiment may be substantially free of F₂.

(SiO₂+TiO₂+ZrO₂)

A sum (SiO₂+TiO₂+ZrO₂) of the SiO₂ content, the TiO₂ content, and the ZrO₂ content may be, for example, 58% or more. A sum of the SiO₂ content, the TiO₂ content, and the ZrO₂ content may be 58.5% or more, 59% or more, 59.5% or more, 60% or more, 60.5% or more, or even 61% or more. The glass composition having a high (SiO₂+TiO₂+ZrO₂) is suitable for achieving a high acid resistance. The upper limit of (SiO₂+TiO₂+ZrO₂) is not limited to a particular one, and is, for example, 63.5% or less, 63% or less, or even 62.5% or less.

(SiO₂+Al₂O₃+MgO)

A sum (SiO₂+Al₂O₃+MgO) of the SiO₂ content, the Al₂O₃ content, and the MgO content may be 95% or more, 96% or more, 97% or more, or even 97.5% or more. The sum (SiO₂+Al₂O₃+MgO) may be, for example, 99% or less, or even 98.5% or less.

### (CaO+R₂O)

Addition of CaO and the alkali metal oxides (R₂O) is suitable for adjustment of the devitrification temperature of the glass composition. A sum (CaO+R₂O) of the CaO content and the R₂O content may be 0 to 2.5%. The lower limit of (CaO+R₂O) may be, for example, 0.05% or more, 0.1% or more, 0.3% or more, 0.5% or more, 0.7% or more, or even 1% or more. The upper limit of (CaO+R₂O) may be, for example, 2.3% or less, 2.2% or less, 2% or less, or even 1.8% or less.

### (Additional Components)

The glass composition may include a component other than those described above. The additional component that can be included in the glass composition are, for example, Fe₂O₃, Y₂O₃, La₂O₃, SrO, BaO, Cl₂, SnO₂, CeO₂, P₂O₅, or SO₃.

Fe₂O₃ is added to account for, for example, 0 to 1%. The upper limit of the Fe₂O₃ content may be 0.5%, 0.3% or less, 0.2% or less, 0.15% or less, or even 0.1 or less. The glass composition of the present embodiment may be substantially free of Fe₂O₃. It should be noted that although part of iron oxide is present as FeO in the glass composition, the iron oxide content is calculated as Fe₂O₃, as is conventional.

Y₂O₃ and La₂O₃ are optional components that contribute to improvement of the Young's modulus. However, raw materials of these components are relatively expensive. A sum of a Y₂O₃ content and a La₂O₃ content is, for example, 0 to 5%. The upper limit of the sum of the Y₂O₃ content and the La₂O₃ content may be 3% or less, 2% or less, 1% or less, or even 0.5% or less. The glass composition of the present embodiment may be substantially free of Y₂O₃. The glass composition of the present embodiment may be substantially free of La₂O₃, either.

The SrO, BaO, Cl₂, SnO₂, CeO₂, P₂O₅, and SO₃ contents are each, for example, 0 to 0.5%. The upper limit of the content of each of these components may be 0.3% or less, 0.2% or less, or even 0.1% or less. The glass composition of the present embodiment may be substantially free of each of these components.

### (Composition Example a Containing 16% or More of MgO)

The glass composition of the present embodiment may include the following components:

| | |
|---|---|
| SiO₂ | 50 to 65%; |
| B₂O₃ | 0 to 1.5%; |
| Al₂O₃ | 10 to 25%; |
| MgO | 16 to 20%; |
| CaO | 0 to 7%; |
| Li₂O | 0 to 1.0%; |
| Na₂O | 0 to 0.2%; |
| K₂O | 0 to 0.1%; |
| TiO₂ | 0 to 5%; and |
| ZrO₂ | 0 to 5%, |

where
a sum of a SiO₂ content, a TiO₂ content and a ZrO₂ content is 58% or more, and
a sum of the TiO₂ content and the ZrO₂ content is 0.1% or more.
   (Composition Example B where a MgO Content is Less than 16%, and ZrO₂ is Included)

The glass composition of the present embodiment may include the following components:

| | |
|---|---|
| SiO₂ | 50 to 65%; |
| B₂O₃ | 0 to 1.5%; |
| Al₂O₃ | 10 to 30%; |
| MgO | 10 to 16% (excluding 16%); |
| CaO | 0 to 7%; |
| Li₂O | 0 to 1.0%; |
| Na₂O | 0 to 0.2%; |
| K₂O | 0 to 0.1%; |
| TiO₂ | 0 to 5%; and |
| ZrO₂ | 0.1 to 5%, |

where
a sum of a SiO₂ content, a TiO₂ content, and a ZrO₂ content is 58% or more.

In Composition Example B, a content of each component can be adjusted with reference to the aforementioned ranges. However, the Al₂O₃ content can be adjusted to a slightly higher level, for example, 22 to 29%, or even 23.5 to 28%.

(Composition Example C, which is Particularly Favorable in Acid Resistance)

The glass composition of the present embodiment may include the following components:

| | |
|---|---|
| SiO₂ | 55 to 65%; |
| B₂O₃ | 0 to 1.5%; |
| Al₂O₃ | 10 to 28%; |
| MgO | 10 to 20%; |
| CaO | 0 to 7%; |
| Li₂O | 0 to 1.0%; |
| Na₂O | 0 to 0.2%; |
| K₂O | 0 to 0.1%; |
| TiO₂ | 0 to 5%; and |
| ZrO₂ | 1.2 to 5%, |

where
a sum of a SiO₂, content, a TiO₂ content and a ZrO₂ content is 60.4% or more. The ZrO₂ content in Composition Examples A to C may be 1.5 to 3%.

### <Properties>

### (Young's Modulus)

The glass composition of the present embodiment has a Young's modulus of, for example, 98 GPa or more. The lower limit of the Young's modulus can be 99 GPa or more, 99.5 GPa or more, or, in some cases, 100 GPa or more. The upper limit of the Young's modulus is not limited to a particular one, and may be, for example, 115 GPa or less, or even 110 GPa or less.

### (Acid Resistance)

The acid resistance can be evaluated by a mass decrease rate ΔW (%) obtained by a test described in EXAMPLES. The mass decrease rate ΔW of the glass composition of the present embodiment is, for example, 0.3 mass % or less. The upper limit of the mass decrease rate ΔW can be 0.25 mass % or less, or even 0.1 mass % or less.

### [Glass Fiber]

The glass composition of the present embodiment is suitable for manufacturing a glass fiber. The glass fiber may be a long glass fiber or a short glass fiber. The glass fiber may be in a form of, for example, at least one selected from the group consisting of a strand, a roving, a yarn, a cloth, a chopped strand, glass wool, and a milled fiber. The cloth is, for example, a roving cloth or a yarn cloth.

Because of its excellent properties, the glass composition of each of the above embodiments can also be used as a shaped glass product other than a glass fiber. An example of the shaped glass product is a glass particle. The glass particle can be manufactured by breaking the glass fiber so finely that the outer shape of the glass fiber is lost or by using, as for the glass fiber, a nozzle having a shape corresponding to an intended shape. The glass composition of each of the above embodiments is also suitable for manufacturing the glass particle without undergoing devitrification. In one embodiment of the present invention, the glass particle includes the glass composition of any of the above embodiments or is formed of the glass composition of any of the above embodiments.

The glass particle may be, for example, an equivalent of at least one selected from the group consisting of a glass flake, a glass powder, a glass bead, and a fine flake. The glass particle can be included in FRPs. In other words, the glass particle can be used for reinforcement, for example, of a reinforced body typically formed of a resin.

Taking into account the fact that the above-described glass composition can be included also in the glass particle, the above-described glass composition can be regarded as a glass composition for glass fibers or glass particles.

### [Non-Woven Fabric, Rubber-Reinforcing Cord]

Each glass fiber provided by the present invention can be used in the same applications as conventional glass fibers. In one embodiment of the present invention, a non-woven glass fiber fabric including the glass fiber is provided. In another embodiment of the present invention, a rubber-reinforcing cord including a strand including a bundle of the glass fibers is provided. The glass fiber can also be used in other applications. Examples of the other applications include reinforcement of a reinforced body typically formed of a resin.

### EXAMPLES

Hereinafter, the embodiment of the present invention will be described in more detail by Examples and Comparative Examples. The contents of components in composition are expressed in mass % also in the tables below.

### <Preparation of Glass Composition>

Common glass raw materials such as silica sand were blended to give each glass composition shown in Tables 1 and 2, and glass raw material batches were prepared for Examples and Comparative Examples. Each batch was molten by heating it to 1500 to 1600 °C using an electric furnace, and the molten state was maintained for about 4 hours until the composition became uniform. After that, part of the molten glass (glass melt) was poured onto an iron plate, and was slowly cooled to room temperature in an electric furnace. A glass composition (sheet-shaped body; glass specimen) as a bulk was obtained in this manner. Properties of thus-obtained glass compositions were evaluated as follows. The results are collectively shown in Tables 1 and 2.

(Young's modulus)

The Young's modulus was determined by an equation E=3ρ·vₗ²·(vₗ²−4/3·vₜ²)/(vₗ²−vₜ²). A longitudinal wave velocity vₗ and a transverse wave velocity vₜ were measured by an ordinary ultrasonic method for an elastic wave propagating through glass. A density ρ in the equation E was separately measured for the glass by Archimedes' principle.

### (Acid Resistance)

A glass monofilament having a diameter of 15 μm was cut to a length of 20 mm, and was weighed in grams equivalent to the specific gravity of the glass. The glass fiber was immersed for 60 minutes in 80 mL of an aqueous sulfuric acid solution having a temperature of 99 °C and a specific gravity of 1.2. A mass decrease rate was determined for this case and was defined as ΔW.

The above mass decrease rates were calculated by the following equation, where Wa is the mass before the immersion, and Wb is the mass after the immersion.

Mass decrease rate (%)={(Wa−Wb)/Wa}×100

TABLE 1

| Examples | 1 | 2 | 3 | 4 | 5 | 6 | 7 | 8 |
|---|---|---|---|---|---|---|---|---|
| SiO₂ | 57.62 | 59.64 | 59.62 | 59.53 | 59.90 | 57.85 | 56.73 | 60.06 |
| Al₂O₃ | 20.41 | 20.24 | 20.24 | 20.21 | 21.18 | 24.54 | 27.28 | 20.39 |
| B₂O₃ | 0.00 | 0.00 | 0.06 | 0.00 | 0.00 | 0.06 | 0.05 | 0.00 |
| MgO | 18.49 | 16.67 | 16.63 | 17.30 | 17.41 | 14.20 | 12.65 | 16.79 |
| CaO | 0.94 | 0.93 | 0.93 | 0.93 | 0.00 | 0.90 | 0.88 | 0.93 |
| Li₂O | 0.50 | 0.49 | 0.49 | 0.00 | 0.50 | 0.48 | 0.47 | 0.50 |
| Na₂O | 0.00 | 0.00 | 0.00 | 0.00 | 0.00 | 0.00 | 0.00 | 0.00 |
| K₂O | 0.00 | 0.00 | 0.00 | 0.00 | 0.00 | 0.00 | 0.00 | 0.00 |
| Fe₂O₃ | 0.00 | 0.00 | 0.00 | 0.00 | 0.00 | 0.00 | 0.00 | 0.00 |
| TiO₂ | 0.00 | 0.00 | 0.00 | 0.00 | 0.00 | 0.00 | 0.00 | 1.33 |
| ZrO₂ | 2.05 | 2.03 | 2.03 | 2.03 | 1.02 | 1.97 | 1.94 | 0.00 |
| SiO₂ + TiO₂ + ZrO₂ | 60.4 | 60.3 | 61.2 | 60.5 | 61.6 | 61.4 | 60.0 | 61.8 |
| Acid resistance ΔW | 0.070 | 0.205 | 0.024 | 0.050 | 0.200 | 0.080 | 0.120 | 0.240 |
| Young's modulus E | 101.9 | 100.6 | 100.6 | 100.3 | 100.3 | 100.9 | 101.6 | 100.0 |
| (GPa) | | | | | | | | |

TABLE 2

| Comparative Examples | 1 | 2 |
|---|---|---|
| SiO₂ | 57.29 | 59.11 |
| Al₂O₃ | 21.13 | 23.40 |
| B₂O₃ | 1.15 | 1.14 |
| MgO | 16.04 | 15.86 |
| CaO | 3.72 | 0.00 |
| Li₂O | 0.50 | 0.49 |
| Na₂O | 0.11 | 0.00 |
| K₂O | 0.00 | 0.00 |
| Fe₂O₃ | 0.06 | 0.00 |
| TiO₂ | 0.00 | 0.00 |
| ZrO₂ | 0.00 | 0.00 |
| SiO₂ + TiO₂ + ZrO₂ | 57.29 | 59.11 |
| Acid resistance ΔW | 0.312 | 0.200 |
| Young's modulus E | 100.0 | 97.5 |
| (GPa) | | |

Each Example achieved a Young's modulus of 98 GPa or more, and a mass decrease rate ΔW of 0.3% or less. On the other hand, each Comparative Example failed to satisfy these properties.

As described above, the present description discloses the following techniques.

### (Technique 1)

A glass composition for glass fibers, including, in mass %:

| | |
|---|---|
| SiO₂ | 50 to 65%; |
| Al₂O₃ | 10 to 30%; |
| MgO | 10 to 20%; |
| CaO | 0 to 7%; |
| TiO₂ | 0 to 5%; and |
| ZrO₂ | 0 to 5%, |

where
a sum of a SiO₂ content, a TiO₂ content and a ZrO₂ content is 58% or more,
a sum of the TiO₂ content and the ZrO₂ content is 0.1% or more, and
when a MgO content is 10% or more and less than 16%, the glass composition includes 0.1% or more of ZrO₂.

### (Technique 2)

The glass composition according to Technique 1, including, in mass %:

| | |
|---|---|
| SiO₂ | 55 to 62%; |
| Al₂O₃ | 15 to 30%; |
| MgO | 12 to 20%; |
| CaO | 0 to 4%; |
| TiO₂ | 0 to 3%; and |
| ZrO₂ | 0 to 3%. |

### (Technique 3)

The glass composition according to Technique 1 or 2, wherein the sum of the TiO₂ content and the ZrO₂ content is 0.5% or more and 5% or less in mass %.

### (Technique 4)

The glass composition according to any one of Techniques 1 to 3, wherein the SiO₂ content is in the range of 57.5% to 61.5% in mass %.

### (Technique 5)

The glass composition according to any one of Techniques 1 to 4, wherein a Li₂O content is in the range of 0 to 1.5% in mass %.

### (Technique 6)

The glass composition according to any one of Techniques 1 to 5, wherein a sum of a Na₂O content and a K₂O content is in the range of 0 to 1% in mass %.

### (Technique 7)

The glass composition according to any one of Techniques 1 to 6, wherein a B₂O₃ content is in the range of 0 to 1.5% in mass %.

### (Technique 8)

The glass composition according to any one of Techniques 1 to 7, wherein a sum of a Y₂O₃ content and a La₂O₃ content is in the range of 0 to 5% in mass %.

### (Technique 9)

The glass composition according to any one of Techniques 1 to 8, having a Young's modulus of 98 GPa or more.

### (Technique 10)

The glass composition according to any one of Techniques 1 to 9, wherein

ΔW is 0.3 mass % or less, where ΔW is a mass decrease rate determined for a case where the glass composition has a mass in grams equivalent to a specific gravity of the glass composition and is immersed for 60 minutes in 80 mL of a sulfuric acid solution having a specific gravity of 1.2 and a temperature of 99 °C

### (Technique 11)

A glass fiber including the glass composition according to any one of Techniques 1 to 10.

### (Technique 12)

The glass fiber according to Technique 11, being in a form of at least one selected from the group consisting of a strand, a roving, a yarn, a cloth, a chopped strand, glass wool, and a milled fiber.

1. A glass composition for a glass fiber, comprising, in mass %:

| | |
|---|---|
| SiO₂ | 50 to 65%; |
| Al₂O₃ | 10 to 30%; |
| MgO | 10 to 20%; |
| CaO | 0 to 7%; |
| TiO₂ | 0 to 5%; and |
| ZrO₂ | 0 to 5%, |

wherein
a sum of a SiO₂ content, a TiO₂ content and a ZrO₂ content is 58% or more,
a sum of the TiO₂ content and the ZrO₂ content is 0.1% or more, and
when a MgO content is 10% or more and less than 16%, the glass composition includes 0.1% or more of ZrO₂.

2. The glass composition according to claim 1, comprising, in mass %:

| | |
|---|---|
| SiO₂ | 55 to 62%; |
| Al₂O₃ | 15 to 30%; |
| MgO | 12 to 20%; |
| CaO | 0 to 4%; |
| TiO₂ | 0 to 3%; and |
| ZrO₂ | 0 to 3%. |

3. The glass composition according to claim 1, wherein the sum of the TiO₂ content and the ZrO₂ content is 0.5% or more and 5% or less in mass %.

4. The glass composition according to claim 1, wherein the SiO₂ content is in the range of 57.5% to 61.5% in mass %.

5. The glass composition according to claim 1, wherein a Li₂O content is in the range of 0 to 1.5% in mass %.

6. The glass composition according to claim 1, wherein a sum of a Na₂O content and a K₂O content is in the range of 0 to 1% in mass %.

7. The glass composition according to claim 1, wherein a B₂O₃ content is in the range of 0 to 1.5% in mass %.

8. The glass composition according to claim 1, wherein a sum of a Y₂O₃ content and a La₂O₃ content is in the range of 0 to 5% in mass %.

9. The glass composition according to claim 1, having a Young's modulus of 98 GPa or more.

10. The glass composition according to claim 1, wherein AW is 0.3 mass % or less, where ΔW is a mass decrease rate determined for a case where the glass composition has a mass in grams equivalent to a specific gravity of the glass composition and is immersed for 60 minutes in 80 mL of sulfuric acid having a specific gravity of 1.2 and a temperature of 99 °C.

11. A glass fiber comprising the glass composition according to claim 1.

12. The glass fiber according to claim 11, being in a form of at least one selected from the group consisting of a strand, a roving, a yarn, a cloth, a chopped strand, glass wool, and a milled fiber.
